(19) United States
(12) Patent Application Publication
(10) Pub. No.: US 2008/0116032 A1
(43) Pub. Date: May 22, 2008

(54) SINGLE-BILL OUTPUT CONTROL OF A BILL DISPENSER

(75) Inventors: Hung-Yi Chang, Chiling City (TW); Ting-Kuo Lin, Taoyuan Hsien (TW); Chih-Ching Liao, Yunlin Hsien (TW)

Correspondence Address: INTERNATIONAL CURRENCY TECHNOLOGIES CORPORATION, 2F-4. NO. 148, SEC. 4, CHUNG HSIAN EAST ROAD, TAIPEI, TW

(73) Assignee: INTERNATIONAL CURRENCY TECHNOLOGIES CORPORATION, Taipei City (TW)

(21) Appl. No.: 12/021,305

(22) Filed: Jan. 29, 2008

Related U.S. Application Data
(63) Continuation-in-part of application No. 11/161,893, filed on Aug. 22, 2005.

(51) Int. Cl. G07F 7/04

(52) U.S. Cl. 194/206

(57) ABSTRACT

A bill dispenser is disclosed to include an optical transmitter module and an optical receiver module for measuring the transmittance of the bill being dispensed toward the bill outlet, and a control circuit for comparing the transmittance measured by the optical receiver module with a reference value and controlling the operation of the dispensing roller set of the bill dispenser subject to the comparison result, assuring accurate dispensing of one single bill at a time.

This application is a Continuation-In-Part of my patent application Ser. No. 11/161,893, filed on Aug. 22, 2005.

### BACKGROUND OF THE INVENTION

1. Field of the Invention

The present invention relates to bill dispensers and more particularly, to such a single-bill output control of a bill dispenser, which dispenses only one single bill at a time.

2. Description of the Related Art

Following fast development of modern technology, our mode of living has been changed. Various automatic vending machines (ticket venders, coin exchanging machines, etc.) are used everywhere to sell different products without serviceman. These automatic vending machines save much labor and bring convenience to people. An automatic vending machine may be quipped with a bill dispenser to dispense bills (cards, tickets, coupons, banknotes, etc.). However, due to thin thickness of bills, bills may be not smoothly dispensed, or two or more bills may be overlapped and delivered to the bill outlet at a time. Manufacturers are trying hard to design bill dispensers that can dispense bills smoothly and individually.

FIG. 8 is a schematic side view of a bill dispenser according to the prior art. As illustrated, the bill dispenser A comprises an accommodation chamber A1, a gap adjustment device B disposed at the front side of the accommodation chamber A1, a plurality of sheet transferring rollers A2 disposed at the bottom side of the accommodation chamber A1, a motor A3 controlled to rotate the sheet transferring rollers A2 and to transfer bills C out of the accommodation chamber A1 to the bill path controlled by the gap adjustment device B. According to this design, the circumferential length of the sheet transferring rollers A2 is shorter than the length of the bills C, and the sheet transferring rollers A2 are molded from a material having a high friction force, for example, rubber. Therefore, the sheet transferring rollers A2 keep transferring bills C forwards when rotated. To control dispensing of one single bill C at a time, the ratio between the circumferential length of the sheet transferring rollers A2 and the length of the bills C must be measured. However, this limitation does not allow the bill dispenser to dispense different sizes of bills C. Further, the sheet transferring roller A2 transfer bills C by means of a friction force. However, due to precision reason, the gap adjustment device B may no adjust a gap of the bill path to fit the thickness of one single bill C precisely. In this case, two overlapped or stacked bills C may be dispensed. If the gap of the gap adjustment device B allows only one single bill C to pass, follow-up bills C may be jammed in the gap adjustment device B or in between the gap adjustment device B and the accommodation chamber A1, resulting in failure in functioning of the bill dispenser A.

Therefore, it is desirable to provide an individual bill output control method for bill dispenser that eliminates the aforesaid problems.

### SUMMARY OF THE INVENTION

The present invention has been accomplished under the circumstances in view. It is therefore the main object of the present invention to provide a bill dispenser, which dispenses one single bill accurately at a time.

To achieve this and other objects of the present invention, the bill dispenser comprises a housing, which comprises a frameboard, a bill chamber defined above the frameboard, an accommodation chamber defined below the frameboard, a bill outlet in the front side, a bill passage in communication between the bill chamber and the bill outlet, a bill-empty sensor mounted in the frameboard and adapted for providing a bill-empty signal when the bill chamber is empty, a transferring roller set mounted in the accommodation chamber and adapted for transferring bills out of the bill chambers toward the bill passage, a dispensing roller set mounted in the bill chamber between the frameboard and the bill passage and adapted for dispensing bills been transferred by the transfer roller set, an optical transmitter module adapted for transmitting a light across the bill passage when the dispenser roller set is dispensing a bill through the bill passage toward the bill outlet, an optical receiver module adapted for receiving the light that is transmitted by the optical transmitter module and passing through the bill being dispensed through the bill passage toward the bill outlet by the dispensing roller set and outputting an output signal indicative of the intensity of the light received, and a control circuit adapted for receiving the output signal of the optical receiver module and comparing the output signal of the optical receiver module with a predetermined reference value and controlling the operation of the dispensing roller set and the transferring roller set subject to the comparison result.

### BRIEF DESCRIPTION OF THE DRAWINGS

FIG. 1 is an elevational view of a bill dispenser according to the present invention.

FIG. 2 is an exploded view of the bill dispenser according to the present invention.

FIG. 3 is a schematic side view in an enlarged scale of a part of the bill dispenser according to the present invention.

FIG. 4 is a circuit diagram of the control circuit of the bill dispenser according to the present invention.

FIG. 5 is a schematic sectional side view of the bill dispenser before dispensing of a bill.

FIG. 6 is similar to FIG. 5 but showing a bill dispensed to the bill outlet.

FIG. 7 is an operation flow chart of the present invention.

FIG. 8 is a schematic side view of a bill dispenser according to the prior art.

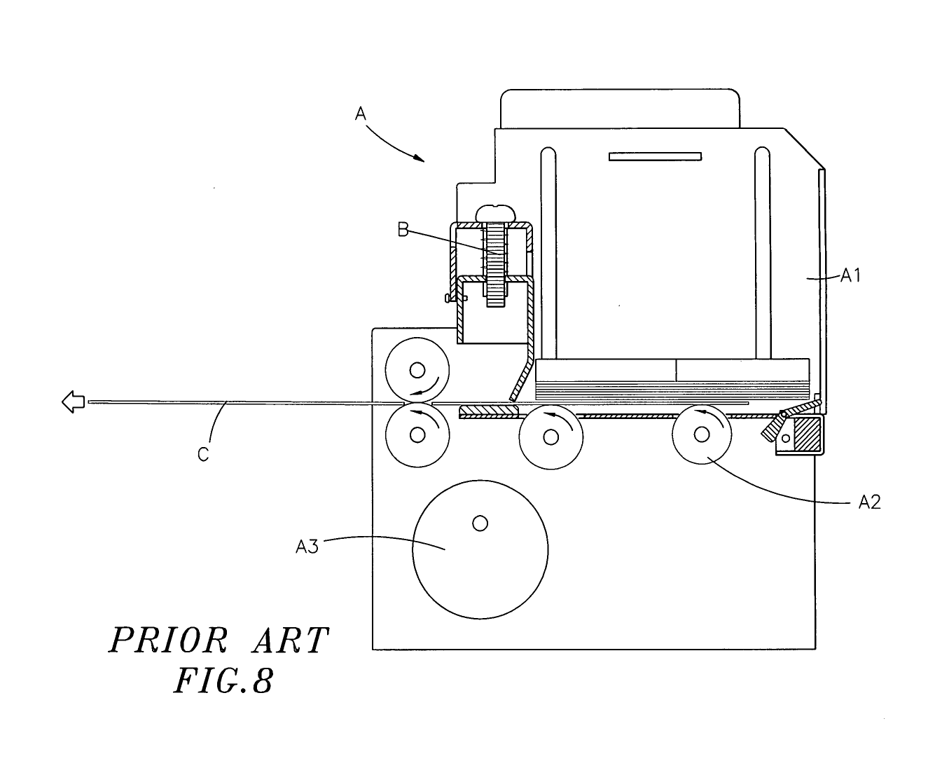

### DETAILED DESCRIPTION OF THE PREFERRED EMBODIMENT

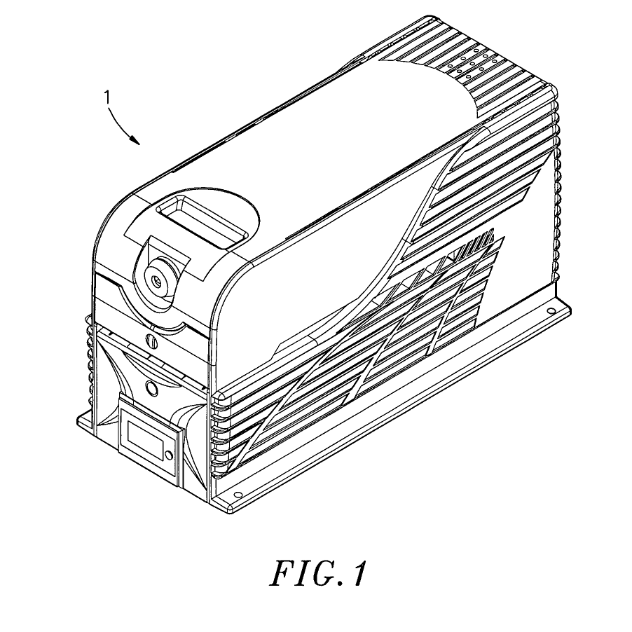

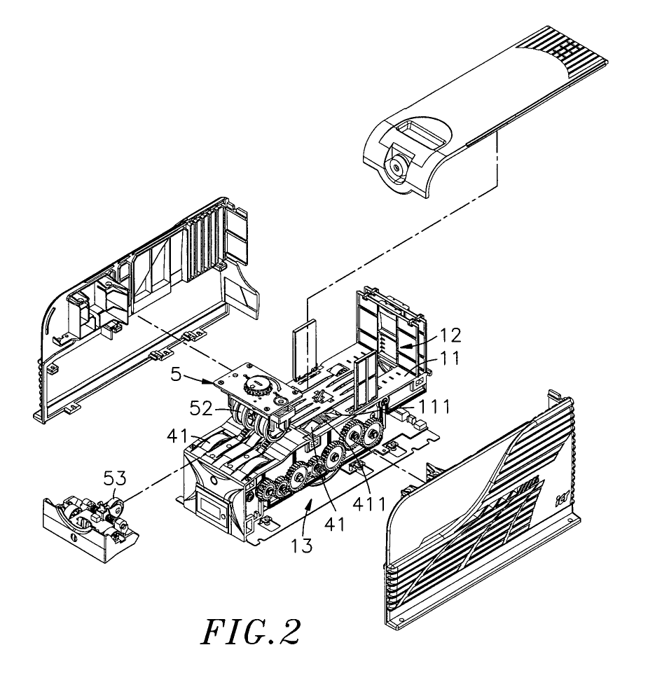

Referring to FIGS. 1-3, a bill dispenser is shown comprising a housing 1, an optical receiver module 2 and an optical transmitter module 3.

The housing 1 is comprised of a bottom shell 101, two side panels 102 and a top cover 103. The housing 1 houses a frameboard 11. The frameboard 11 has a plurality of slots 111 cut through the top and bottom walls thereof, and two upright locating plates 112 symmetrically disposed at two opposite sides. The housing 1 defines a bill outlet 15 in the front side, a bill chamber 12 above the frameboard 11 for accommodating a number of bills of one single denomination, an accommodation chamber 13 below the frameboard 11, and a bill passage 14 in communication between the bill chamber 12 and the bill outlet 15 for guiding one single bill out of the bill chamber 12 to the bill outlet 15 at a time. Further, a bill-empty sensor 113 is installed in the frameboard 11 and adapted for providing a bill-empty signal when the bill chamber 12 is empty.

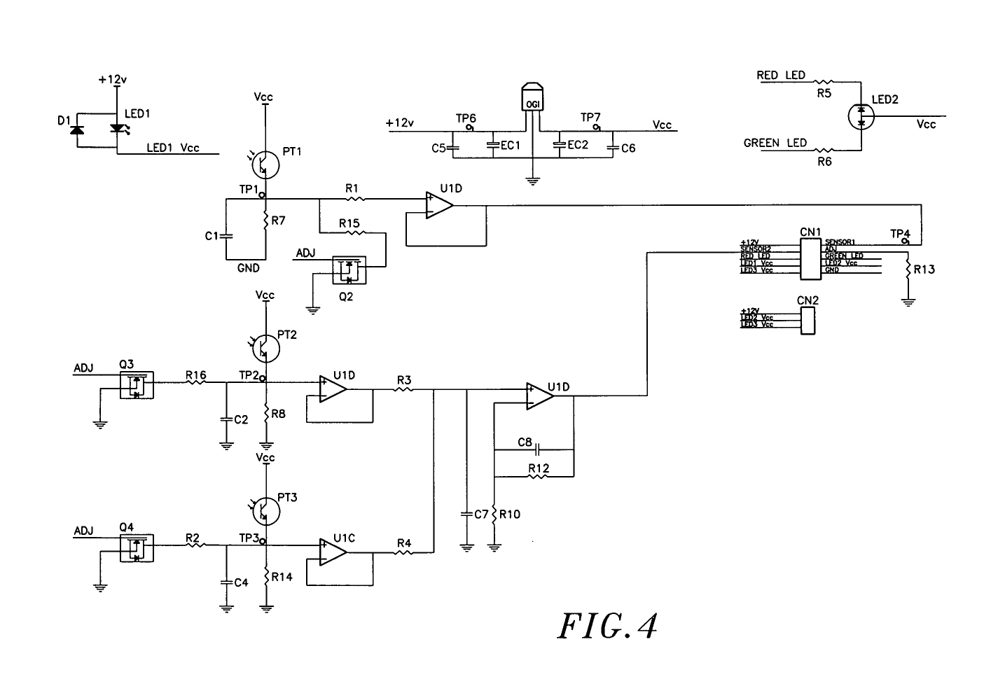

The optical receiver module 2 is mounted in the housing 1 adjacent to the bill outlet 15, for example, at a location beneath the bill passage 14, and comprised of resistors, capacitors, phototransistors and an optical receiving device 21. Further, the optical receiver module 2 is electrically connected to a control circuit (see FIG. 4).

The optical transmitter module 3 is mounted in the housing 1 adjacent to the bill outlet 15, for example, at a location above the bill passage 14, and comprised of resistors, capacitors, phototransistors and an optical transmitting device 31. Further, the optical transmitter module 3 is electrically connected to the control circuit (see FIG. 4). The control circuit controls the electric current going through the optical transmitting device 31, thereby controlling the intensity of the light emitted by the optical transmitting device 31. The light emitted by the light transmitting device 31 goes across the bill passage 14 toward the optical receiving device 21, causing the optical receiving device 21 to output a signal to the control circuit for comparison with a reference value.

The bill dispenser further comprises a transferring roller set 4 and a dispensing roller set 5. The transferring roller set 4 is mounted in the accommodation chamber 13 below the frameboard 11, comprising a number of transferring rollers 41 and an auxiliary roller 42. Some transferring rollers 41 are provided with a respective push block 411. The push blocks 411 are movable through the slots 111 into the bill chamber 12. The dispensing roller set 5 is mounted in the bill chamber 12 between the frameboard 11 and the bill passage 14. The dispensing roller set 5 is mounted in the bill chamber 12 above the frameboard 11, comprising dispensing rollers 51, adjustment rollers 52 and pressure rollers 53. The dispensing rollers 51, the adjustment rollers 52 and the pressure rollers 53 are for contacting the periphery of the transferring rollers 41. The adjustment rollers 52 can be moved vertically to adjust a gap between the respective adjustment rollers 52 and the respective transferring rollers 41.

Further, the optical receiver module 2, the optical transmitter module 3, the transferring roller set 4, the dispensing roller set 5 and the control circuit (see FIG. 4) are electrically coupled to a drive (not shown), so that the control circuit controls the optical receiver module 2 and the optical transmitter module 3 to operate subject to the setting of a predetermined program, and drives the transferring roller set 4 and the dispensing roller set 5 to carry bills and to dispense bills. Further, the housing 1 can be connected to a host (not shown), enabling the host (computer, bill exchange machine or automatic vending machine) to control the operation of the control circuit (see FIG. 4).

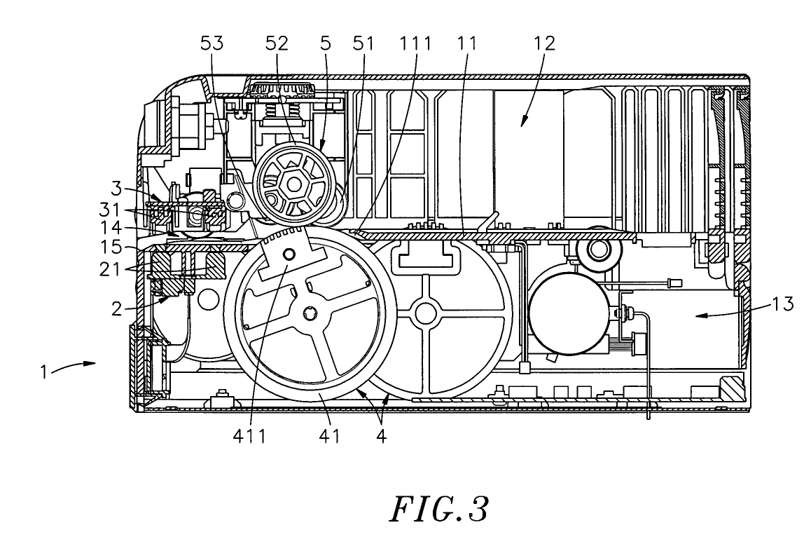

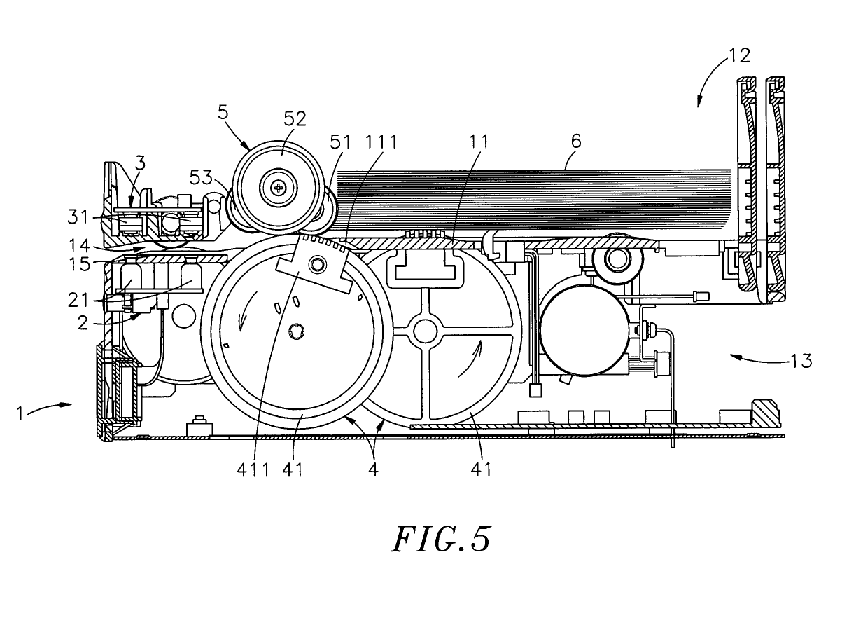

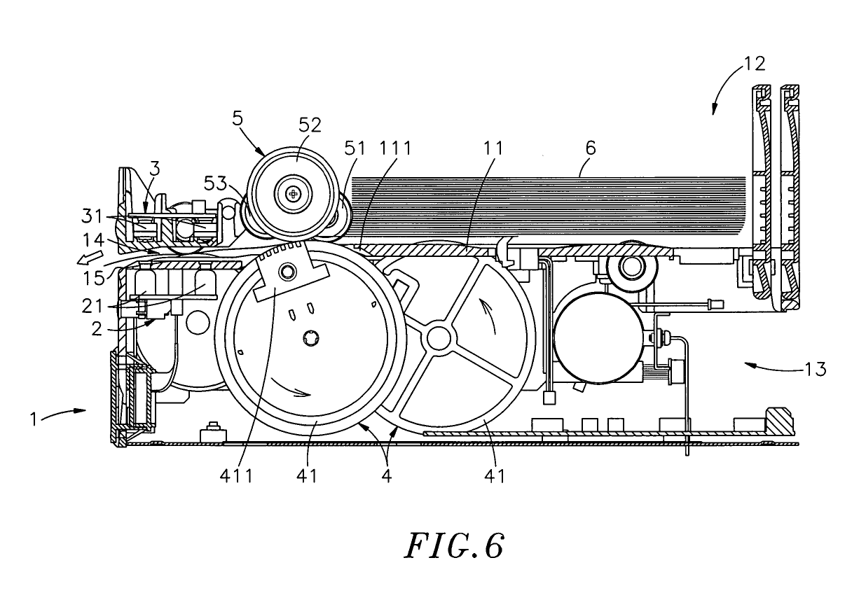

Referring to FIGS. 3, 5 and 6, a stack of bills 6 of one denomination is placed in the bill chamber 12 inside the housing 1. When dispensing a bill, the transferring roller set 4 is rotated clockwise. During rotation of the transferring rollers 41 and the auxiliary roller 42, the push blocks 411 are moved with the respective transferring rollers 41 to rub against the first bill 6, moving the bills 6 out of the bill chamber 12 to the dispensing rollers 51 of the dispensing roller set 5 toward the bill outlet 15. When a number of bills 6 reached the dispensing rollers 51, the dispensing rollers 51 stop the bills 6 into a stepped stack, and move the stepped stack of bills 6 to the pressure rollers 53, for enabling the bills 6 to be dispensed through the gap between the adjustment rollers 52 and the corresponding transferring rollers 41 into the bill passage 14. At this time, the optical receiver module 2 and the optical transmitter module 3 are driven to operate.

When bills 6 are accommodated in the bill chamber 12, the bill-empty sensor 113 is forced downwards by the accommodated bills 6. When the bill chamber 12 is empty, the bill-empty sensor 113 receives no pressure, thereby outputting a signal indicative of the empty status of the bill chamber 12.

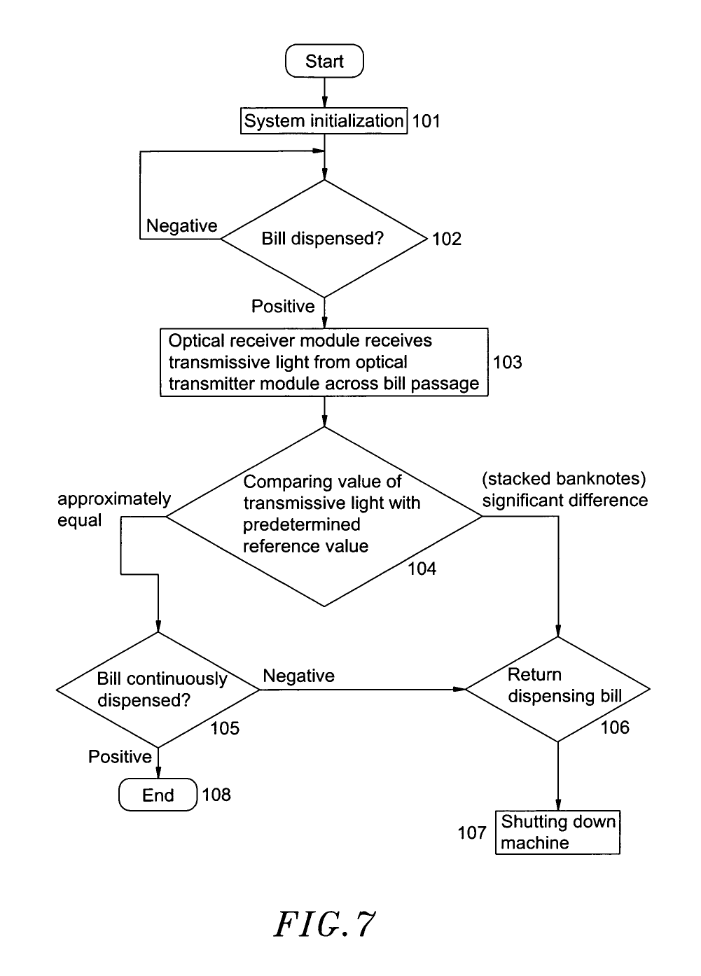

Referring to FIG. 7, during operation of the optical receiver module 2 and the optical transmitter module 3, the control circuit (see FIG. 4) runs subject to the steps as follows:

(101) Start system initialization.

(102) Judge whether or not a bill 6 is been dispensed? And then proceed to step (103) when positive, or step (102) when negative.

(103) The optical transmitter module 3 transmits light toward the bill 6 passing through the bill passage 14, and the optical receiver module 2 receives the transmissive light from the bill 2. And then proceed to step (104).

(104) Compare the value of the transmissive light received by the optical receiver module 2 with a predetermined reference value, and then proceed to step (105) if the difference of the comparison result is within a predetermined range, or proceed to step (106) if the difference of the comparison result surpasses the predetermined range.

(105) The optical transmitter module 3 and the optical receiver module 2 keep detecting whether or not there is any bill 6 been dispensed? And then proceed to step (108) if positive, or step (106) if negative (beyond a predetermined length of time).

(106) Reverse the dispensing roller set 5 to return the dispensing bill 6, and then proceed to step (107).

(107) Shut down the machine for troubleshooting.

(108) End.

As stated above, the invention uses an optical transmitter module 3 and an optical receiver module 2 to measure the transmittance of the light passing through the bill 6 that is being delivered through the bill passage 14 for comparison with a predetermined reference value. When two or more bills 6 are delivered through the bill passage 14, the transmittance of the light passing through the bills 6 shows a significant difference relative to the predetermined reference value, and the control circuit will immediately reverse the dispensing roller set 5 to return the bills 6.

Further, the aforesaid reference value can be the transmittance of one single bill. Alternatively, the reference value can be the mean value of the transmittance of every single one of a predetermined number of bills been dispensed through the bill dispenser, then the reference value is programmed in the setting program of the control circuit.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A bill dispenser comprising
a housing, said housing comprising a frameboard, a bill chamber defined above said frameboard, an accommodation chamber defined below said frameboard, a bill outlet in a front side thereof, a bill passage in communication between said bill chamber and said bill outlet;
a bill-empty sensor mounted in said frameboard and adapted for providing a bill-empty signal when said bill chamber is empty;
a transferring roller set mounted in said accommodation chamber and adapted for transferring bills out of said bill chamber toward said bill passage, said transferring roller set comprising a plurality of transferring rollers and a plurality of auxiliary rollers; and
a dispensing roller set mounted in said bill chamber between said frameboard and said bill passage and adapted for dispensing bills been transferred by said transfer roller set;
wherein:
the bill dispenser further comprises:
an optical transmitter module mounted inside said housing adjacent to said bill outlet and adapted for transmitting a light across said bill passage when said dispenser roller set is dispensing a bill through said bill passage toward said bill outlet;
an optical receiver module mounted inside said housing adjacent to said bill outlet corresponding to said optical transmitter module adapted for receiving the light that is transmitted by said optical transmitter module and passes through said bill being dispensed through said bill passage toward said bill outlet by said dispensing roller set and outputting an output signal indicative of the intensity of the light received; and
a control circuit adapted for receiving the output signal of said optical receiver module, comparing the output signal of said optical receiver module with a predetermined reference value, and controlling the operation of said dispensing roller set and said transferring roller set subject to a comparison result.

2. The bill dispenser as claimed in claim 1, wherein said housing is formed of a bottom shell, two side panels and a top cover.

3. The bill dispenser as claimed in claim 1, wherein said frameboard comprises a plurality of slots in communication between said bill chamber and said accommodation chamber for accommodating said transferring rollers and said auxiliary rollers of said transferring roller set.

4. The bill dispenser as claimed in claim 3, wherein said transferring rollers each have a push block insertable through said slots of said frameboard into said bill chamber for pushing bills out of said bill chamber toward said dispensing roller set; said dispensing roller set comprises a plurality of dispensing rollers, a plurality of adjustment rollers and a plurality of pressure rollers.

5. The bill dispenser as claimed in claim 4, wherein said dispensing rollers, said adjustment rollers and said pressure rollers are set corresponding to said transferring rollers; said adjustment rollers being vertically movable to adjust a gap between said adjustment rollers and said transferring rollers for the passing of bills from said bill chamber toward said bill passage individually.

6. The bill dispenser as claimed in claim 1, wherein said optical transmitter module is electrically connected with said control circuit, comprised of a plurality of resistors, a plurality of capacitors, a plurality of phototransistors and an optical transmitting device; said control circuit controls the intensity of light transmitted by said optical transmitting device of said optical transmitter module by means of controlling the electric current passing through said optical transmitting device.

7. The bill dispenser as claimed in claim 1, wherein said optical receiver module is electrically connected with said control circuit, comprised of a plurality of resistors, a plurality of capacitors, a plurality of phototransistors and an optical receiving device, said optical receiving device receiving the light passing from said optical transmitting device across said bill passage and outputting a corresponding output signal to said control circuit for comparison with said predetermined reference value.

8. The bill dispenser as claimed in claim 1, wherein said reference value is the mean value of the transmittance of every single one of a predetermined number of bills been dispensed through said bill passage to said bill outlet by said dispensing roller set.
